(19) United States
(12) Patent Application Publication
(10) Pub. No.: US 2022/0355840 A1
(43) Pub. Date: Nov. 10, 2022

(54) UNMANNED AERIAL VEHICLE (UAV) SYSTEMS AND METHODS FOR MAINTAINING ROADWAY PERSONNEL SAFETY

(71) Applicant: Easy Aerial Inc., Brooklyn, NY (US)

(72) Inventors: Timothy Tenne, Towson, MD (US); Ido Gur, New York, NY (US)

(73) Assignee: Easy Aerial Inc., Brooklyn, NY (US)

(21) Appl. No.: 17/737,388

(22) Filed: May 5, 2022

Related U.S. Application Data
(60) Provisional application No. 63/185,449, filed on May 7, 2021.

(51) Int. Cl. B61L 23/06; H04W 4/38; H04W 4/42; B64C 39/02

(52) U.S. Cl. CPC B61L 23/06; H04W 4/38; H04W 4/42; B64C 39/024; B64C 39/022; B64C 2201/122

(57) ABSTRACT

An unmanned aerial vehicle (UAV) system for maintaining roadway personnel safety includes a monitoring device configured to be worn by a user and to provide a notification, a UAV including a sensor configured to sense a signal indicating a railway condition and/or a railway event, and a ground station configured to house the UAV when the UAV is not in use. The ground station is further configured to be mounted on a train or vehicle. The system further includes a processor and a memory that contains instructions, which, when executed by the processor, cause the system to selectively deploy the UAV from the ground station when the ground station is supported on the train or the vehicle, receive the signal from the sensor, detect the railway condition and/or the railway event based on the received signal, and transmit the notification to the monitoring device based on the based on the sensed signal.

### CROSS-REFERENCE TO RELATED APPLICATIONS

This application claims the benefit of U.S. Provisional Application Ser. No. 63/185,449, filed May 7, 2021, the entire contents of which are incorporated by reference herein.

### TECHNICAL FIELD

This disclosure relates to aircraft, and more particularly, to systems and methods for maintaining roadway personnel safety using an unmanned aerial vehicle (UAV).

### BACKGROUND

Current roadway (e.g., railway) safety measures require permanent and costly installation and necessitate regular maintenance and upkeep, as well as initial and ongoing training for personnel. Some solutions install permanent “beacons” along railways that emit sounds or lights when a train is approaching. These solutions require additional personnel to travel to maintain and inspect them. In addition to these inherent drawbacks, these solutions are precluded from being quickly implemented in temporary situations and leave workers unprotected in locations requiring maintenance and/or installation.

### SUMMARY

In accordance with aspects of this disclosure, an unmanned aerial vehicle (UAV) system for maintaining roadway personnel safety includes a monitoring device configured to be worn by a user and to provide a notification, a UAV including a sensor configured to sense a signal indicating a railway condition and/or a railway event, and a ground station configured to house the UAV when the UAV is not in use. The ground station is further configured to be mounted on a train or vehicle. The system further includes a processor and a memory that contains instructions, which, when executed by the processor, cause the system to selectively deploy the UAV from the ground station when the ground station is supported on the train or vehicle, receive the signal from the sensor, detect the railway condition and/or the railway event based on the received signal, and transmit the notification to the monitoring device based on the sensed signal.

In an aspect of this disclosure, the instructions, when executed by the processor, may further cause the system to display the transmitted alert by the monitoring device based on the detected railway condition and/or the railway event, based on the sensed signal.

In an aspect of this disclosure, the sensor may include radar. LIDAR, and/or an imaging device.

In another aspect of this disclosure, the UAV may be tethered to the ground station.

In yet another aspect of this disclosure, the instructions, when executed by the processor, may further cause the system to: sense, by a second sensor, an object relative to the user based on a location of the user; classify the object based on a convolutional neural network; determine a proximity of the object relative to the user; and display a second notification on the monitoring device indicating the determined proximity and the classification of the object.

In a further aspect of this disclosure, the instructions, when executed by the processor, may further cause the system to transmit the notification to a second monitoring device disposed on the train.

In yet a further aspect of this disclosure, the instructions, when executed by the processor, may further cause the system to transmit a command to reduce a speed of the train based on the determined proximity of the train to the user.

In an aspect of this disclosure, the ground station may include a display, strobe lights, a speaker, and/or an airhorn.

In another aspect of this disclosure, the ground station may be further configured to notify a user of the detected railway condition and/or event.

In yet another aspect of this disclosure, the ground station may further include a wireless transceiver configured to communicate sensor signals and a location of the UAV to a remote server.

In accordance with aspects of this disclosure, a computer-implemented method for maintaining roadway personnel safety includes: selectively deploying a UAV from a ground station that is supported on a train or vehicle, the UAV including a sensor, receiving a signal from the sensor, the signal indicating railway condition and/or railway event; detecting the railway condition and/or railway event, based on the received signal; and transmitting a notification to a monitoring device of a user based on the detected condition and/or railway event, based on the sensed signal.

In accordance with aspects of this disclosure, the method may further include displaying the transmitted alert by the monitoring device based on the detected condition and/or railway event, based on the sensed signal.

In an aspect of this disclosure, the UAV may be tethered to the ground station.

In another aspect of this disclosure, the sensor may include radar, LIDAR, and/or an imaging device.

In a further aspect of this disclosure, the method may further include sensing an object relative to the user based on a location of the user, classifying the object based on a convolutional neural network, determining a proximity of the object relative to the user, and displaying a second notification on the monitoring device indicating the determined proximity and the classification of the object.

In yet another aspect of this disclosure, the method may further include transmitting the notification to a second monitoring device disposed on the train.

In an aspect of this disclosure, the method may further include transmitting a command to reduce speed of the train based on the determined proximity of the object.

In another aspect of this disclosure, the method may further include transmitting to a ground station the notification of the detected railway condition and/or railway event.

In an aspect of this disclosure, the ground station may be further configured to notify a user of the detected railway condition and/or railway event.

In accordance with aspects of this disclosure, a non-transitory computer-readable medium stores instructions which, when executed by a processor, cause the processor to perform a method including: selectively deploying a UAV from a ground station that is supported on a train or vehicle, the UAV including a sensor; receiving a signal from the sensor, the signal indicating railway condition and/or railway event; detecting the railway condition and/or the railway event, based on the received signal; and transmitting a notification to a monitoring device of a user based on the detected railway condition and/or the railway event.

Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIGS. 1A and 1B are perspective views of an unmanned aerial vehicle (UAV) system for maintaining roadway personnel safety in accordance with the principles of this disclosure;

FIG. 2 is a block diagram of a controller configured for use with the UAV system of FIGS. 1A and 1B;

FIG. 3 is a block diagram of an exemplary method for maintaining roadway personnel safety in accordance with the disclosure;

FIG. 4 is a flow diagram of a machine learning algorithm of the computer-controlled method for maintaining roadway personnel safety using the UAV system of FIGS. 1A and 1B; and

FIG. 5 is a diagram of layers of a neural network of FIG. 4 in accordance with aspects of the disclosure.

Other aspects, features, and advantages will be apparent from the description, the drawings, and the claims that follow.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure, any features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

The disclosed technology includes systems and methods that maintain roadway personnel safety along roadways, such as railways, with unmanned aerial vehicles (UAV). By integrating a UAV with a vehicle, end-to-end roadway personnel safety, unparalleled ability to reduce or eliminate roadway personnel injuries and/or fatalities, and increased safety and compliance for hazardous transportation environments is enabled. In addition, the UAV system may also be deployed at railroad crossings and other locations along the roadway to prevent trespasser and vehicle strikes and collisions. When deployed in these environments, the drone can detect incoming railway traffic and, via connected personal monitoring devices, notify roadway personnel of said traffic well in advance of that traffic becoming a threat to the worker's safety.

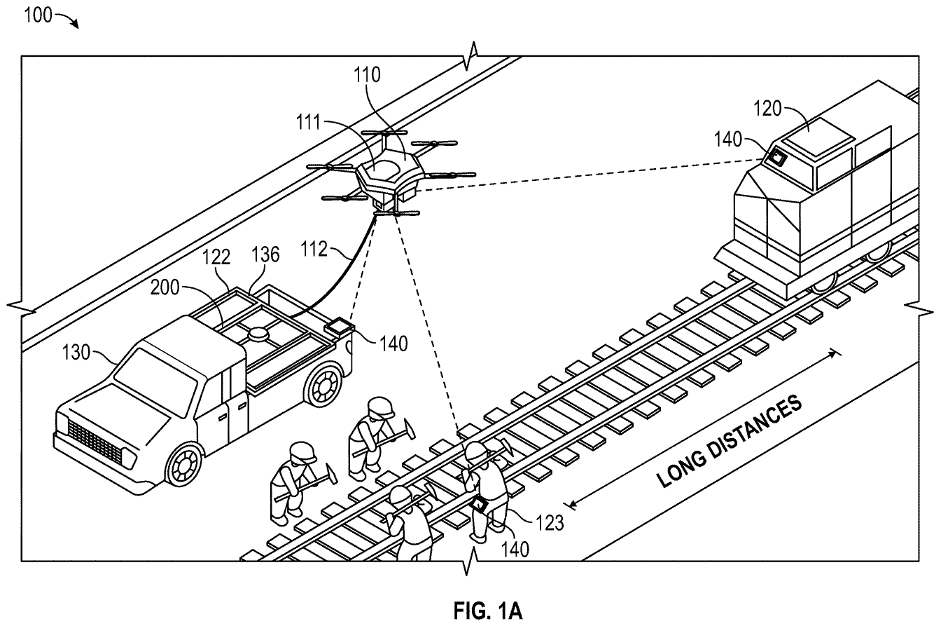

FIGS. 1A and 1B illustrate an unmanned aerial vehicle (UAV) system 100 for maintaining roadway personnel safety. The system 100 generally includes a ground station 122 supported on a train 120 or a vehicle 130 (e.g., supported on a truck bed) remote from the train 120, a UAV 110 (e.g., a drone), a monitoring device 140, and a controller 200.

The monitoring device 140 of UAV system 100 is configured to provide a notification to alert a user and/or roadway personnel of a potentially dangerous situation such as incoming railway traffic. The monitoring device 140 may be worn by a user 123 (e.g., roadway personnel). The monitoring device 140 may be configured to provide a visual alert (e.g., text, symbol, light, etc.), an audible alert (e.g., any suitable speech, tone, volume, buzzing, beeping, bell, ring, etc.), a tactile alert (e.g., vibration, pushing, prodding, pinching, tightening, etc.) and/or any other suitable feedback means to provide a warning of possible incoming danger.

The ground station 122 of UAV system 100 may be supported on a vehicle 130 or an external platform (e.g., via any suitable mounting technique, such as fastening, friction it, and/or straps/chains, etc.) integrated into the vehicle 130 or train 120. The ground station 122 is configured to house the UAV 110 when UAV 110 is not in use. The ground station 122 may be disposed on and/or integrated with any vehicle 130, for example, a truck, or train 120. The ground station 122 generally includes a base plate, a power supply (not shown), and a communication transceiver (not shown). The ground station 122 is configured to supply power and/or communications to the UAV 110, and to store the UAV when the UAV is not in use. The ground station 122 may include telemetry systems, wireless and/or wired communications, battery charging systems, and/or geolocation systems. The ground station 122 may include a notification device 136 such as a display, strobe lights, a speaker, and/or an airhorn. The notification device 136 may be configured to notify a user of any detected railway traffic and/or event.

It is contemplated that the of UAV system 100 may utilize one or more UAVs 110. As can be appreciated, ground station 122 can have any suitable configuration for hosting any number of UAVs. For example, a base triangle (e.g., with three interconnected plates to host at least three UAVs such as one on each of the three outer surfaces of the triangle and/or one or more on each of the inner and/or outer surfaces thereof), a base square (e.g., with four interconnected plates to host at least four UAVs such as one on each of the four outer surfaces of the square and/or one or more on the inner and/or outer surfaces thereof), etc. may be provided. One way to implement a ground station is described in U.S. Patent Application Publication No. US 2022-0019247 A1, the contents of which are incorporated by reference herein in its entirety.

The train 120 may include, for example, a locomotive (or other rail cars) and/or other fixed path vehicles (such as a tram, streetcar, and/or trolley). For instance, as seen in FIG. 1B, ground station 122 may be coupled to an outer surface of a roof of the locomotive.

The UAV 110 of UAV system 100 generally includes a positioning system (e.g., GPS), a video system (not shown), sensors 111, and a wireless communication transceiver (not shown). The wireless transceiver is configured to communicate video, geolocation from the positioning system, and any relevant status of the UAV, or components thereof, such as status of the UAV, to the ground station 122 or other monitoring stations in accordance with any suitable techniques known to persons of ordinary skill in the art. The sensors may include, for example, radar. LIDAR, and/or imaging device(s).

In order to enable continuous surveillance of an area, the UAV 110 may be tethered by a tether system 112 to the ground station 122. In some aspects, the UAV 110 may be untethered and/or selectively untetherable for enabling UAV 110 to roam or fly freely about the train/tracks. The tether system 112 may be a permanent physical link in the form of one or more flexible wires and/or cables. The tether system 112 may be configured to provide power and/or communications to the UAV 110. In aspects, the UAV may include wireless communications. For example, the UAV 110 may be tethered to a locomotive, inspecting rail cars that trail the locomotive. The tethered UAV 110 flying alongside the locomotive can, for example, inspect track ahead, surveil the surroundings for security purposes, such as to prevent burglary, and/or to provide situational awareness to an operator in case of emergency. One way to implement a UAV 110 with a tether is described in U.S. Pat. No. 11,220,335, the contents of which are incorporated by reference herein in its entirety.

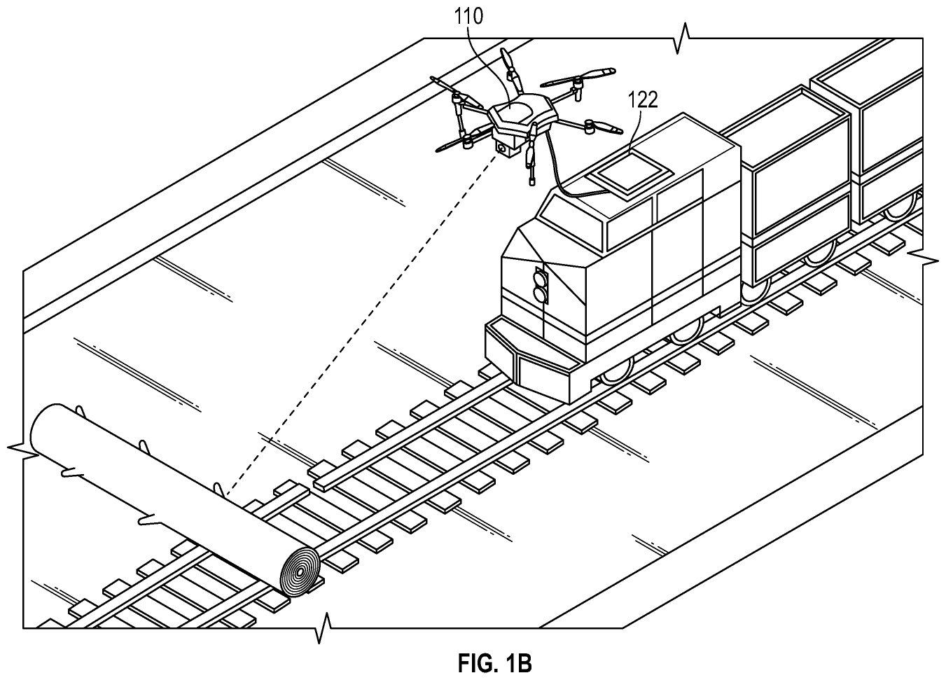

FIG. 2 illustrates the controller 200 of UAV system 100 that includes a processor 220 connected to a computer-readable storage medium or a memory 230. The computer-readable storage medium or memory 230 may be a volatile type memory, e.g., RAM, or a non-volatile type memory, e.g., flash media, disk media, etc. In various aspects of the disclosure, the processor 220 may be another type of processor such as, without limitation, a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data.

The disclosed method may run on the controller 200 or on a user device, including, for example, on a mobile device, an IoT device, or a server system.

The controller 200 is configured to receive, among other data, the UAV status, sensor 111 signals, and UAV location, and control, among other features, the baseplate's position and deployment of the UAV(s). The controller 200 may be further configured to control the operation of the storage and deployment of the UAVs.

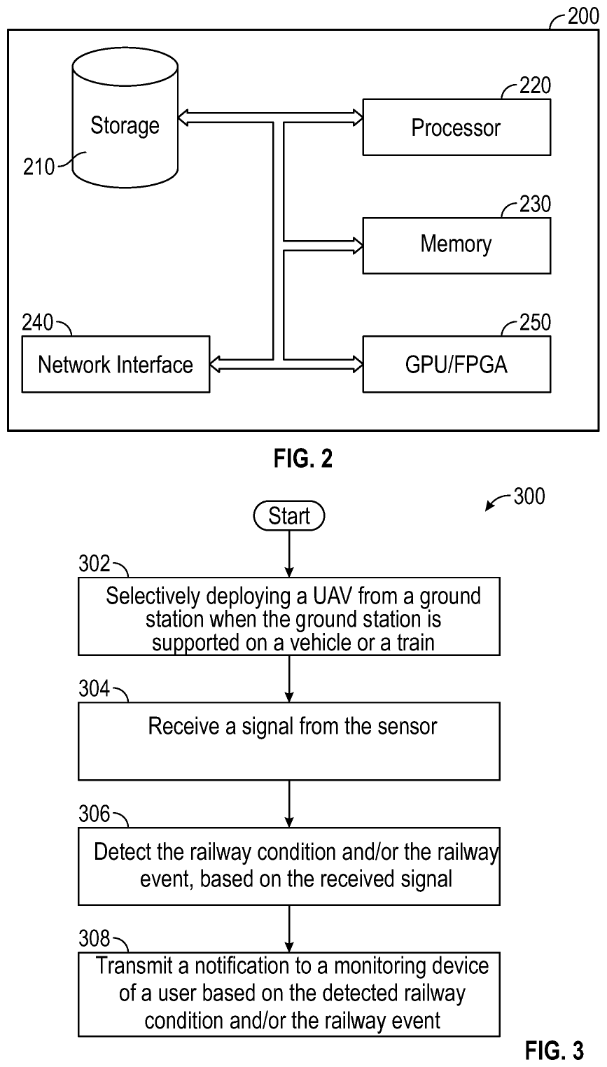

FIG. 3 shows a flow chart illustrating the various operations of an exemplary method for maintaining roadway personnel safety. Persons skilled in the art will appreciate that one or more operations of the method 400 may be performed in a different order, repeated, and/or omitted without departing from the scope of the disclosure. In various aspects, the illustrated method 300 can operate in controller 200 (FIG. 2), in a remote device, or in another server or system. Other variations are contemplated to be within the scope of the disclosure. The operations of method 300 will be described with respect to a controller, e.g., controller 200 of system 100 (FIG. 1A), but it will be understood that the illustrated operations are applicable to other systems and components thereof as well.

By tethering the UAV 110 to a ground station 122 integrated into a train (FIG. 1B), the disclosed technology provides for on-the-go track inspection, 360-degree situational awareness, on-track obstacle avoidance (e.g., for hazards in proximity to, and including, the tracks, railway traffic, criminal activity such as burglary prevention, theft prevention, and/or vandalism prevention, etc.), and/or event/disaster awareness.

Initially, at step 302, a UAV 110 is deployed from a ground station 122 disposed on a vehicle 130 (e.g., on a work truck) or train 120. In aspects, the UAV 110 is tethered to the ground station 122 by a tether 112. The UAV 110 may be deployed at a railroad crossing and/or other locations along the roadway to prevent strikes and/or collisions to trespassers and/or vehicles. The deployed UAV 110 may provide additional safety and awareness to roadway personnel include: roadway worker protection, grade crossing monitoring, trespasser surveillance, yard patrols, maintenance, inspection, and/or safety assurance (PPE and/or task monitoring).

In aspects, the disclosed technology enables 360-degree situational awareness and roadway personnel safety via imaging device(s) that provide 360-degree imaging. In aspects, the controller may process the 360-degree images to determine if a railway traffic and/or a condition/hazard exists in proximity to the user 123 (e.g., within a number of miles, a thousand yards, a hundred feet, etc., or less/more, although any suitable distance may be provided).

Next, at step 304, the controller 200 receives a signal from a sensor 111 on the UAV 110. The sensor may include radar, LIDAR, and/or an imaging device. The imaging device may further include infrared imaging and/or visual light imaging. The sensor 111 is configured to provide a signal indicative of a condition or event (e.g., railway traffic and/or an event relative to the user). For example, the sensor 111 may be a radar sensor, which detects, for example, an obstruction on the track. In another example, the sensor 111 may be an infra-red imaging device and may detect, for example, an incoming train 120.

Next, at step 306, the controller 200 detects the condition or event based on the received signal. For example, the controller 200 may determine that the signal indicates that the condition is an incoming storm. The deployed UAV 110 can detect incoming railway traffic, day and night, in typical and/or atypical (e.g. adverse) weather conditions.

Next, at step 308, the controller 200 transmits the notification to a monitoring device 140 (FIG. 1A) based on the detected condition or event, based on the sensed signal. The monitoring device 140 (e.g., a personal monitoring device) may display the transmitted alert and/or may provide an audio alert. The monitoring device 140 may notify roadway personnel well in advance of any danger.

The user has access to real time video from the UAV 110 via the ground station 122, providing further awareness and insight into fast changing railway safety conditions. Moreover, because the ground station 122, which is also the triggering system, is located alongside the roadway personnel, ground station 122 can be outfitted with additional capabilities for providing advance warning to the roadway personnel. Strobe lights, loudspeakers, alarms, air horns, etc. and other notification methods can be deployed to additionally warn roadway personnel. In aspects, the video feed from the UAV 110 can be integrated into dispatching systems, command and control operations centers, and/or other systems as required.

In aspects, the controller 200 may display, on a display, an indication of the determined condition and/or event. For example, the controller 200 may display, for the engineer/conductor (and/or other personnel/passengers), a warning to slow the train or stop the train based on the blocked track. In aspects, the display may be remote from the train so that a remote controller may remotely effectuate efforts to stop the train such as from a remote control center in communication with train and/or UAV 110.

For example, the disclosed technology may enable hazard detection in any direction. The controller 200 may receive a signal from a sensor 111 on the UAV 110. The controller may detect a potential hazard, such as an object on the track like a fallen tree, a pedestrian, a car, or a rock. Next, the controller 200 may classify the object based on a machine learning classifier (e.g., a convolutional neural network or a support vector machine). Next, the controller 200 may determine the distance between the object and the train 120. The controller 200 may send an indication of the distance/proximity and the classification of the object to the locomotive control panel (or to another device such as a mobile phone or a central terminal) to alert the train personnel (e.g., engineer, driver, etc.). In aspects, the controller 200 may decrease the speed of the train 120 or change the direction/track of the train 120.

In aspects, the controller 200 may detect a hazard out of a line of sight of the train 120 based on the determined condition and/or event. The controller 200 may determine a proximity of the hazard relative to the train and display a notification indicating the determined distance and the classification of the hazard.

The system 100 may enable rail worker safety by sensing rail workers (as classified by a classifier) in and around the train 120. For example, the controller 200 would be able to automatically control the braking system of the locomotive and/or visually/audio alert the locomotive operator if controller determines that people are on the tracks. For example, the sensors on the UAV 110 can identify trains over five miles, enabling enough time for the user to get off the track and for the train stopping distance which can reach about two miles. In aspects, the controller 200 may receive a signal from the sensor 111, indicating that a rail worker is working on the rails and/or the train. For example, the controller 200 may stop the train 120 from moving in a case where the object is classified as a person, and the proximity is within a predetermined distance of the train. The controller 200 may then stop the train 120 from moving forwards and/or may transmit and/or display an alert warning to the train personnel (e.g., the engineer, driver, etc.) of the location of the rail workers.

The disclosed technology enables quickly deploying equipment in temporary situations. In aspects, the disclosed technology enables 360-degree situational awareness, train car monitoring, trespasser monitoring, and vehicle crossing monitoring, and enhanced roadway worker protection.

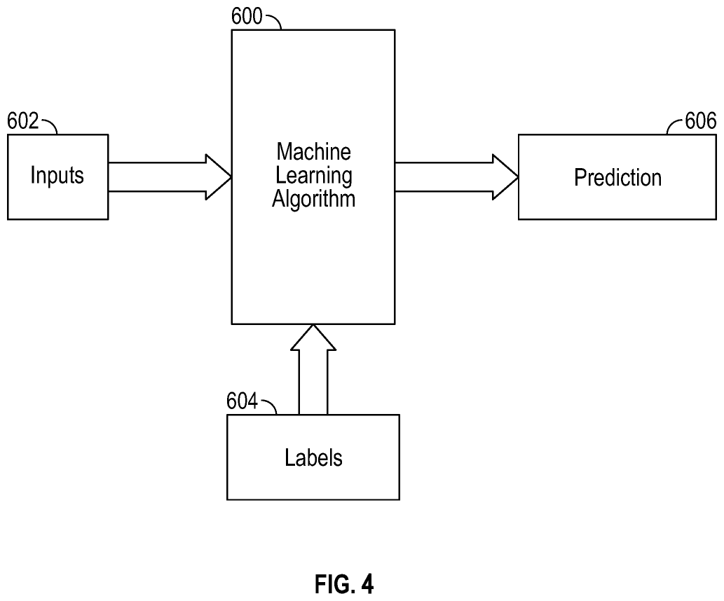

With reference to FIG. 4, the controller 200 may include a machine-learning algorithm 600 configured to make these evaluations. For example, the controller 200 may use machine learning to classify images. For example, machine learning may include a convolutional neural network (CNN) and/or a support vector machine (SVM). The CNN may be trained on previous image data, for example, images of objects such as trees, weather, people, animals, and/or vehicles.

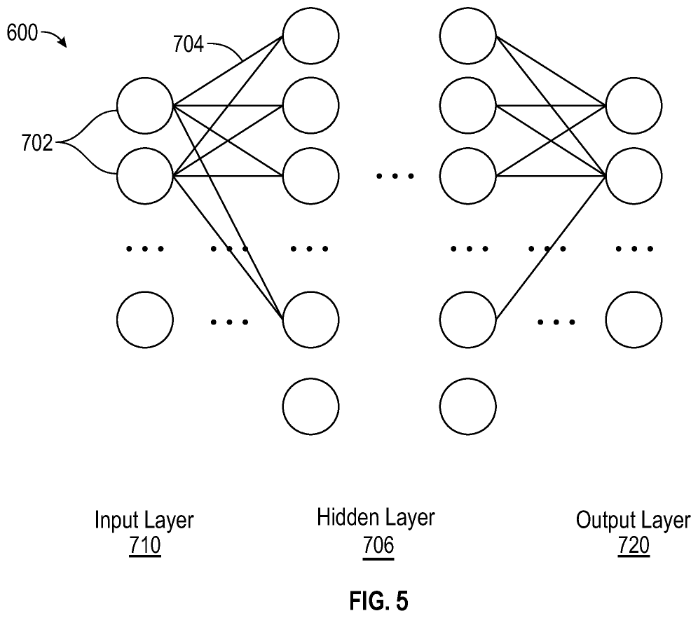

Referring to FIG. 5, generally, the machine learning network 600 (e.g., a convolutional deep learning neural network) of FIG. 4 includes at least one input layer 710, a plurality of hidden layers 706, and at least one output layer 720. The input layer 710, the plurality of hidden layers 706, and the output layer 720 all include neurons 702 (e.g., nodes). The neurons 702 between the various layers are interconnected via weights 674. Each neuron 702 in the machine learning network 600 computes an output value by applying a specific function to the input values coming from the previous layer. The function that is applied to the input values is determined by a vector of weights 704 and a bias. Learning, in the deep learning neural network, progresses by making iterative adjustments to these biases and weights. The vector of weights 704 and the bias are called filters (e.g., kernels) and represent particular features of the input (e.g., a particular shape). The machine learning network 600 may output logits.

It should be understood that the disclosed structure can include any suitable mechanical, electrical, and/or chemical components for operating the disclosed system or components thereof. For instance, such electrical components can include, for example, any suitable electrical and/or electromechanical, and/or electrochemical circuitry, which may include or be coupled to one or more printed circuit boards. As appreciated, the disclosed computing devices and/or server can include, for example, a “controller,” “processor,” “digital processing device” and like terms, and which are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various embodiments, the memory can be random access memory, read-only memory, magnetic disk memory, solid state memory, optical disc memory, and/or another type of memory. In various embodiments, the memory can be separate from the controller and can communicate with the processor through communication buses of a circuit board and/or through communication cables such as serial ATA cables or other types of cables. The memory includes computer-readable instructions that are executable by the processor to operate the controller. In various embodiments, the controller may include a wireless network interface to communicate with other computers or a server. In embodiments, a storage device may be used for storing data. In various embodiments, the processor may be, for example, without limitation, a digital signal processor, a microprocessor, an ASIC, a graphics processing unit (“GPU”), field-programmable gate array (“FPGA”), or a central processing unit (“CPU”).

The memory stores suitable instructions, to be executed by the processor, for receiving the sensed data (e.g., sensed data from GPS, camera, etc. sensors), accessing storage device of the controller, generating a raw image based on the sensed data, comparing the raw image to a calibration data set, identifying an object based on the raw image compared to the calibration data set, transmitting object data to a ground-based post-processing unit, and displaying the object data to a graphic user interface. Although illustrated as part of the disclosed structure, it is also contemplated that a controller may be remote from the disclosed structure (e.g., on a remote server), and accessible by the disclosed structure via a wired or wireless connection. In embodiments where the controller is remote, it is contemplated that the controller may be accessible by, and connected to, multiple structures and/or components of the disclosed system.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

As can be appreciated, securement of any of the components of the disclosed systems can be effectuated using known securement techniques such welding, crimping, gluing, fastening, etc.

The phrases “in an aspect,” “in aspects,” “in various aspects,” “in some aspects,” or “in other aspects” may each refer to one or more of the same or different aspects in accordance with the present disclosure. Similarly, the phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in any appropriately detailed structure. Like reference numerals may refer to similar or identical elements throughout the description of the figures.

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. An unmanned aerial vehicle (UAV) system for maintaining roadway personnel safety, the system comprising:
a monitoring device configured to be worn by a user and to provide a notification;
a UAV including a sensor, the sensor configured to sense a signal indicating a railway condition and/or a railway event;
a ground station configured to house the UAV when the UAV is not in use, the ground station further configured to be mounted on a train or a vehicle;
a processor; and
a memory, containing instructions thereon, which, when executed by the processor, cause the system to:
selectively deploy the UAV from the ground station when the ground station is supported on the train or the vehicle;
receive the signal from the sensor;
detect the railway condition and/or the railway event, based on the received signal; and
transmit the notification to the monitoring device based on the detected railway condition and/or the railway event.

2. The system of claim 1, wherein the instructions, when executed by the processor, further cause the system to:
display the transmitted alert by the monitoring device based on the detected railway condition and/or the railway event, based on the sensed signal.

3. The system of claim 1, wherein the sensor includes radar, LIDAR, and/or an imaging device.

4. The system of claim 1, wherein the UAV is tethered to the ground station.

5. The system of claim 1, wherein the instructions, when executed by the processor, further cause the system to:
sense, by a second sensor, an object relative to the user based on a location of the user;
classify the object based on a convolutional neural network;
determine a proximity of the object relative to the user; and
display a second notification on the monitoring device indicating the determined proximity and the classification of the object.

6. The system of claim 5, wherein the instructions, when executed by the processor, further cause the system to:
transmit the notification to a second monitoring device disposed on the train.

7. The system of claim 5, wherein the instructions, when executed by the processor, further cause the system to:
transmit a command to reduce speed of the train based on the determined proximity of the train to the user.

8. The system of claim 1, wherein the ground station includes a display, strobe lights, a speaker, and/or an airhorn.

9. The system of claim 1, wherein the ground station is further configured to notify a user of the detected railway condition and/or railway event.

10. The system of claim 1, wherein the ground station further includes a wireless transceiver configured to communicate sensor signals and location of the UAV to a remote server.

11. A computer-implemented method for maintaining roadway personnel safety, comprising:
selectively deploying a UAV from a ground station that is supported on a train or a vehicle, the UAV including a sensor;
receiving a signal from the sensor, the signal indicating railway condition and/or railway event;
detecting the railway condition and/or the railway event, based on the received signal; and
transmitting a notification to a monitoring device of a user based on the detected railway condition and/or the railway event.

12. The computer-implemented method of claim 11, further comprising displaying the transmitted alert by the monitoring device based on the detected railway condition and/or the railway event, based on the sensed signal.

13. The computer-implemented method of claim 11, wherein the UAV is tethered to the ground station.

14. The computer-implemented method of claim 11, wherein the sensor includes radar, LIDAR, and/or an imaging device.

15. The computer-implemented method of claim 11, further comprising:
sensing an object relative to the user based on a location of the user;
classifying the object based on a convolutional neural network;
determining a proximity of the object relative to the user; and
displaying a second notification on the monitoring device indicating the determined proximity and the classification of the object.

16. The computer-implemented method of claim 15, further comprising:
transmitting the notification to a second monitoring device disposed on the train.

17. The computer-implemented method of claim 15, further comprising:
transmitting a command to reduce speed of the train based on the determined proximity of the object.

18. The computer-implemented method of claim 15, further comprising:
transmitting to a ground station the notification of the detected railway condition and/or railway event.

19. The computer-implemented method of claim 18, wherein the ground station is further configured to notify a user of the detected railway condition and/or railway event.

20. A non-transitory computer-readable medium storing instructions which, when executed by a processor, cause the processor to perform a method comprising:
selectively deploying a UAV from a ground station that is supported on a train or a vehicle, the UAV including a sensor;
receiving a signal from the sensor, the signal indicating a railway condition and/or a railway event;
detecting the railway condition and/or the railway event, based on the received signal; and
transmitting a notification to a monitoring device of a user based on the detected railway condition and/or the railway event.
